(19) United States
(12) Patent Application Publication
(10) Pub. No.: US 2016/0205462 A1
(43) Pub. Date: Jul. 14, 2016

(54) METHOD OF TRANSMITING DATA AND A DEVICE AND SYSTEM THEREOF

(71) Applicant: Well Being Digital Limited, Shatin (HK)

(72) Inventors: Chor Tin MA, Hong Kong (HK); Ming Yip Wallace WONG, Hong Kong (HK)

(21) Appl. No.: 14/596,644

(22) Filed: Jan. 14, 2015

(51) Int. Cl. H04R 1/10; H04B 1/69

(52) U.S. Cl. CPC H04R 1/1091; H04B 1/69; H04R 2420/01

(57) ABSTRACT

A method for transmitting a data signal from a sending-end 100 to a receiving-end 200 includes the steps of spreading the data signal into a spread spectrum signal, combining the spread signal with an analogue signal into a mixed signal. The mixed signal can be transmitted or broadcasted to the receiving-end 200. The receiving-end is able to play or use the analogue signal without significant noise from the spread spectrum signal. The spread spectrum signal can be retrieved by inverse-spread-processing the spread spectrum signal to retrieve the data signal. The sending-end can be in a headphone 900 and the receiving-end can be in a mobile phone 910, or the sending-end can be a loudspeaker broadcasting the analogue signal to a mobile phone picking up the analogue signal by the microphone in the mobile phone.

### TECHNICAL FIELD

The present invention relates to communication technology, and particularly relates to a method and system for analogue signal transmission, and more particularly between a mobile phone and a headphone or a speaker system and receiving terminal.

### BACKGROUND

Mobile phones and similar mobile phone devices have an audio jack into which the connector of a headphone may be plugged for the wearer to listen to music played in the mobile phone. The headphone typically comprises a microphone, and a set of earphones for being placed on the ears of the wearer. The wearer can engage in a conversation while wearing the headphone, by listening to a conversation party by the ear phones and by speaking into the microphone.

The standard audio jack on mobile phones is a 3.5 mm audio jack. This audio jack is dedicated to wired transmission of analogue audio signals between the mobile phone and the headphone, particularly from the microphone to the mobile phone and from the mobile phone to the ear phones. The audio jack is unusable for transmission of non-analogue audio signals such as data, since the audio jack is dedicated to analogue audio signal transmission for tele-conversation.

It is desirable to provide a way of expanding the use of the wired 3.5 mm audio jack to increase functions of a conventional mobile phone.

Furthermore, it is desirable to provide a way by which any analogue audio signal transmitter can be used to transmit non-conversation or non-audio data.

### SUMMARY OF THE INVENTION

In a first aspect, the invention proposes a method of transmitting data between a mobile phone and a headphone plugged to the analogue audio jack of the mobile phone, comprising the steps of: providing a data signal; spreading the data signal to produce a spread spectrum signal having a wider bandwidth than the data signal and a smaller power spectral density than the data signal; sending the spread spectrum signal from the mobile phone to the headphone and inverse-spread-processing the spread spectrum signal in the headphone to retrieve the data signal; or sending the spread spectrum signal from the headphone to the mobile phone and inverse-spread-processing the spread spectrum signal in the mobile phone to retrieve the data signal.

Optionally, there is no need for the spread spectrum signal to have a wider bandwidth than the data signal and a smaller power spectral density than the data signal, although this is preferable.

Preferably, the method further comprises the steps of:
providing an analogue signal;
combining the analogue signal and spread spectrum signal into a mixed signal;
wherein the spread spectrum signal is sent from the mobile phone to the headphone as part of the mixed signal; or the spread spectrum signal is sent from the headphone to the mobile phone as part of the mixed signal.

Advantageously, the invention provides the possibility that a conventional audio jack in mobile phones can be used to transmit to a headphone, or earphone, an analogue audio signal and a data signal at the same time via the same channel of the audio jack. This expands the use of the conventional audio jack which has until now been dedicated to only analogue audio signal transmission. Now, all that is needed in some embodiments is a headphone which can collect a desired data signal, and which can spread the data signal to produce a spread spectrum signal, and combine the spread spectrum signal with an analogue audio signal recorded by the microphone. The data signal can be any information, typically biological data such as heart rate or temperature of the wearer, which is obtained by sensors suitably installed as part of the headphone. The combination produces a mixed signal of the spread spectrum signal and the analogue audio signal. Subsequently, a complementary mobile phone which has been enabled to despread the mixed signal receives the mixed signal through the audio jack and despreads the mixed signal. The despreading process restores and extracts the data signal from the mixed signal. As the skilled man knows, the same despreading process is able to remove or reduce the presence of the analogue audio signal in the retrieved data signal, so that the data signal suffers only an insignificant amount of noise or none at all.

The reverse configuration is also possible, where a conventional audio jack in a mobile phone can be used to transmit a mixed signal to the headphone. In this configuration, an analogue audio signal as well as a piece of data signal are mixed in the same way: the data signal is spread and mixed with the analogue audio signal, and sent by the audio jack to the headphone. This allows a headphone to be controlled by signals sent via the audio jack, which is not possible in the prior art. The analogue audio signal can be a piece of music played in the mobile phone or radio broadcasts received in a radio frequency from the ambient surroundings.

Typically, the data signal contains information to be recorded, processed, played or displayed in the mobile phone.

In a variation of the embodiment, it is possible that two or more data signals are provided at the same time in the same mixed signal, along with the analogue audio signal, both of which can be extracted by the mobile phone. A copy of the mixed signal can be despread using one despread code, and a copy of the same mixed signal can be despread using another despread code, so that the two data signals can be distinguished from each other.

The skilled man understands that the term ‘data signal’ is only used to identify a signal which carries specific information or data, and a data signal can also itself be any suitable analogue signal, even an analogue audio signal or a digital signal.

The term ‘analogue signal’ refers to a signal into which a spread spectrum signal is mixed, the spread spectrum signal being generally unnoticeable by the target person receiving information based on the analogue signal until the spread spectrum signal is despread and retrieved from the mixed signal. Optional terminology may refer to the ‘analogue signal’ as a ‘carrier signal’ and the ‘spread spectrum signal’ as a ‘hidden’ or ‘carried signal’.

Preferably, the method further comprises the steps of: the data signal triggering operation of a function in the headphone when the mixed signal is sent from the mobile phone to the headphone and inverse-spread-processing the spread spectrum signal in the headphone to retrieve the data signal; or the data signal triggering operation of a function in the mobile phone when the mixed signal is sent from the headphone to the mobile phone and inverse-spread-processing the spread spectrum signal in the mobile phone to retrieve the data signal.

Therefore, a mobile phone can now control any function in a headphone by sending a control or instruction signal via the same audio jack and headphone wire, such as to trigger the headphone to monitor heartbeat or temperature of the wearer. This again expands the functions of the audio jack in conventional mobile phones.

Preferably, the audio jack is a 3.5 mm audio jack. This specifically expands the use-ability of the conventional 3.5 mm audio jack.

In a second aspect, the invention proposes a method for transmitting a data signal from an analogue signal sending-end to an analogue signal receiving-end, comprising the steps of: providing a data signal; spread processing the data signal to produce a spread spectrum signal having a wider bandwidth than the data signal and a smaller power spectral density than the data signal; sending the spread spectrum signal to the receiving end; inverse-spread-processing the spread spectrum signal to retrieve the data signal.

The sending-end and the receiving-end can be defined as such in any two respective devices which communicate an analogue signal between them, typically in a wired connection but possibly wirelessly as well. The sending-end can be the headphone as mentioned and the receiving-end a mobile phone or vice versa. The sending-end can be a loudspeaker broadcasting an audio signal to the ambient surroundings, a light source, a microwave source and so on. In different applications, such analogue signals can be used to hide useful message or alerts. For example, a microwave oven cooking food using microwaves can have a data signal hidden in the microwave in the form of a spread spectrum signal. A terminal device which can detect microwaves can be used to despread the data signal and issue a warning of microwaves leaking into the surroundings.

In a third aspect, the invention proposes a method for transmitting a data signal from an analogue signal sending-end to an analogue signal receiving-end, comprising the further steps of: providing an analogue signal; combining the analogue signal and the spread spectrum signal into a mixed signal; wherein sending the spread spectrum signal to the receiving end includes sending the mixed signal to the receiving end.

In a fourth aspect, the invention proposes a device for transmission of an analogue audio signal comprising a sensor for obtaining a data signal; the device capable of code spreading the data signal to produce a spread spectrum signal, the spread spectrum signal having a frequency bandwidth broader than the bandwidth of the data signal and having a power spectral density lesser than the power spectral density of the data signal; wherein the device is capable of transmitting the spread spectrum signal.

Typically, the device is capable of obtaining an analogue audio signal, capable of adding the spread spectrum signal to the analogue audio signal to provide a mixed signal; and capable of transmitting the spread spectrum signal as part of the mixed signal.

Transmission of an analogue signal refers to the taking of an analogue signal and sending it from a transmission end or sending end, to a receiving end, and includes different modes of transmission. For example, the analogue signal can be digitized and transmitted in such a digitized form to the receiving end, and be converted back into the analogue signal at the receiving end. The same applies to the mixed signal comprising the analogue signal and the data signal.

Preferably, the device is capable of transmitting the spread spectrum signal by an analogue signal jack.

Optionally, the device is a microphone. Alternatively, the device is an earphone or headphone. Alternatively, the device is an earphone or headphone having an integral microphone.

Typically, the sensor is a heart rate sensor, a temperature sensor, a gyrometer or an accelerometer, or any combinations thereof.

In a fifth aspect, the invention proposes a new use of a mobile phone having an audio jack, wherein the audio jack is suitable for receiving a spread data signal which has been code spread, and the mobile phone is configured for despreading the spread data signal and obtaining the despread data signal as an instruction for operating a function of the mobile phone.

In a sixth aspect, the invention proposes a loudspeaker system for sending a data signal, such as a text message wherein the loudspeaker system is capable of playing an audible analogue signal mixed with a spread spectrum signal, the spread spectrum signal being a data signal which has been spread processed to have a relatively low spectral power compared to the audible analogue signal, the data signal representing the text message, and the spread spectrum signal is suitable for despreading to retrieve the data signal by a device capable of receiving the audible analogue signal mixed with a spread spectrum signal.

Therefore, the invention provides the possibility that ambient analogue signals broadcasted into the general surroundings of a premises, such as analogue audio signals from a loudspeaker system, can be used to carry data signals to all devices capable of picking up these ambient analogue signals. It is possible in some applications that the analogue signal is not audio but a source of light, or other radio frequency signals or even microwave signals that can be broadcasted to receiving devices and despread to retrieved data signals mixed into the analogue signal.

In a seventh aspect, the invention proposes a device suitable for receiving a spread spectrum signal; wherein the device is capable of detecting the spread spectrum signal when the device apply a despreading process on the spread spectrum signal.

Preferably, the device receives the spread spectrum signal as part of a mixed signal, the mixed signal comprising the spread spectrum signal and an analogue signal, the device having a receiver capable of receiving analogue signals. The spread spectrum signal is detected when the device applies a despreading process to the analogue signal.

Typically, the analogue signal is an analogue audio signal, although it may be another type of analogue signal such as radio frequency, microwave or even a visible radio frequency signal.

Typically, the spread spectrum signal contains information on biological or physiological data of a human or living thing.

Typically, the device is a headphone or a mobile terminal. ‘Mobile terminal’ here refers to mobile phones, personal digital assistants, computer notebooks, any form of computer tablets or smart phones, and so on, suitable for receiving the mixed signals.

In another aspect, the invention proposes a data signal transmission method comprising the steps of: providing a transmitting side to obtain the data signal and the analogue audio signal; wherein the transmission side of the data signal performs a spread spectrum processing to obtain a spread spectrum signal; the transmitting side mixing the data signal with the analogue audio signals into the mixed signal which is then sent to the receiver; the receiver receiving the mixed signal, with the data signal obtained from said mixed signal by inverse spread processing.

Preferably, said step of transmitting said data through spread spectrum processing the signal to obtain a spread spectrum signal includes the transmitting terminal using a preset spreading code of the data signal to obtain a direct sequence spread spectrum signal for directing the spread spectrum processing.

Preferably, said spreading code is an orthogonal spreading code; preset by the transmitting side of the data signal for directing the spreading code sequence spread step, with the frequency spread spectrum signal processed through the preset orthogonal spreading codes, with the data signal multiplied to obtain the spread spectrum signal processed by the transmitting side.

Preferably, the receiving step involves the receiving end receiving the mixed signal to perform the inverse spread spectrum processing of the data signal, wherein the positive, the spreading code and the post down-mix signal is multiplied; the receiving terminal multiplying the signal obtained by said obtaining said data signal.

The data signal transmission method as described is characterized in that said step of transmitting the mixed signal from said transmitting side to the receiving side, the mixed signal is transmitted from the transmitting side through the audio jack to the receiving side .

The inventive method can utilizes as the audio interface a standard wired audio interface of a transmitter, the mixed audio interface signal is sent to a receiver which also has a standard wired audio interface configured for receiving the mixed signal transmitted to the receiver. Preferably, the audio jack is a standard wireline audio jack; the transmitting side after the step of mixing the audio jack signal transmits the mixed signal to the receiving end, through a transmission end of a cable, and through the standard audio jack, the mixed signal is transmitted to the receiver.

Preferably, said standard audio jack is a wired 3.5 mm audio jack; the sending end through a standard interface to the wireline analogue audio signals to the step of mixing the receiving end is: the transmitting side through the audio jack 3.5 mixed signal is transmitted to the receiving end.

Preferably, said sending side, through the step of mixing the data signal and analogue audio signal, is transmitted to the receiving end by modulating the mixed analogue signal with a radio frequency

Preferably, the bandwidth of the data signal is less than the threshold value. This ensures that the spread spectrum signals power spectral density is low enough to be not noticeable.

In a further aspect, the invention proposes a data signal transmission system, including sending and receiving ends, characterized in that said transmitting side comprises a signal-acquisition-module for acquiring the data signal and the analog analogue audio signal;
a spread-spectrum-processing-module for processing said data signal which is spread to obtain a spread spectrum signal;
a signal synthesis module for converting the spread spectrum signal and analog analogue audio signals into the mixed signal;
a transmitter for transmitting the mixed signal to a receiving end;
said receiving end comprising:
a signal-receiving-module for receiving the mixed signal;
a reverse spread processing module for obtaining the data signal from the mixed signal by reversing the spread processing.

Preferably, the transmission system is characterized in that said spread spectrum processing module is further configured to spread by a preset spreading code direct sequence spread spectrum processing to obtain the spread spectrum signal to the data signal.

Preferably, said spreading code is an orthogonal spreading code; wherein the processing module is further spread by an orthogonal spreading code and a preset data signal is multiplied to obtain the spread spectrum signal.

Preferably, said processing module is further configured to reverse the spreading using the orthogonal spreading code wherein the mixed signal is multiplied by multiplying the resulting signal to obtain the data signal.

Preferably, said signal transmitting module is further used by the audio jack for transmitting of the mixed signal to the receiving end.

Preferably, the audio jack is a standard audio jack, the signal transmitting module is further used by the standard audio jack for wired transmission of the mixed signal to the receiving end.

Preferably, the standard audio jack is a wired standard 3.5 mm audio jack, the module further configured to send the mixed signal through the 3.5 mm audio jack to the receiving end.

Preferably, said signal transmitting module is further used for transmitting the mixed signal through a wireless transmission modulation scheme to the receiver end.

Preferably, a bandwidth of the data signal is less than a threshold value.

In a further aspect, the invention proposes a signal transmission control method comprising: a mobile phone terminal which is able to terminate the data transmission; said mobile phone terminal generating a feedback signal to a peripheral device. When the peripheral device receives the feedback signal, it stop sending the data signals.

Preferably, said method further comprises said mobile phone terminal being configured to recover the signal transmission; said mobile phone terminal terminates a feedback signal which is generated in the detection of the peripheral devices. When the feedback signal is not received or the received feedback signal and the mixed signal does not correspond, the transmission data signal is restored.

Preferably, said method further comprises said peripheral device receiving the data transmission to recover the signal, resuming transmission of said peripheral device data signals.

Preferably, said method further comprises said peripheral device transmitting the mixed signal through the audio input interface to the mobile phone terminal.

Preferably, said mobile phone terminal transmits the feedback signal to the step of the peripheral device as follows: the mobile phone terminal through the audio output interface returns the feedback signal to the peripheral device.

Preferably, said receiving terminal terminates the data transmission signal prior to the above step, wherein said mobile phone terminal detects whether there is an incoming call; the mobile phone terminal detects an incoming call and generates the data transfer termination signal; the mobile phone terminal returns a feedback with the mobile phone terminal acquiring the incoming call voice analog analogue audio signal and transmitting the feedback signal to after a synthesis setting means; with a step where said peripheral device receives said feedback signal, the peripheral device obtains by the received signal said feedback signal.

Preferably, said mobile phone terminal is able to, prior to the above step, resume the signal transmission, and wherein if the mobile phone terminal detects that an incoming call hangs up, the mobile phone terminal generates a recovery signal.

In another aspect, the invention proposes a signal transmission system control system including a mobile phone terminal and a peripheral device, wherein said mobile phone terminal comprises: an instruction acquisition module for acquiring a data transfer termination signal; a feedback signal generation module for receiving a mixed signal to generate said feedback signal corresponding to the mixed signal, the mixed signal comprising the identification signal and a data signal and/or an analogue audio signal; a feedback module for sending the feedback signal back to said mobile phone terminal; said peripheral device comprising: a signal transmission module for transmitting the mixed signal to said mobile phone terminal; the feedback module generating a signal-to-signal ratio for mixing the received signal with a comparison to the feedback, and when a signal waveform corresponding to the mixed signal is received, transmits the data signal and notifies of the termination of the signal transmitting module.

Preferably, the instructions to obtain the data acquisition module is further configured to restore the transmission signal, and notifies the termination of the feedback signal generation module generating a feedback signal; a ratio of the signal module is further operable to detect when the feedback signal is not received or the received signal and the feedback signal does not correspond to the mixing, the notification signal transmitting module adapted to signal to resume transmission of the data signal.

Preferably, said peripheral apparatus further includes an instruction-receiving module, configured to receive a data transmission resume signal, the notification signal transmitting module adapted to signal to resume transmission of the data signal.

Preferably, said signal transmitting module is further used for transmitting the mixed signal via the audio input interface to the mobile phone terminal.

Preferably, the signal via the audio output module is further configured to interface to the feedback signal to the peripheral device.

Preferably, said mobile phone terminal further has a call detection module for detecting whether there is an incoming call, generating a data transfer termination signal upon detection of an incoming call; said mobile phone terminal further having a signal synthesis module, for acquiring voice calls analog analogue audio signal and the feedback signal synthesizer; said peripheral device further having a signal filter module for passing the received signal to obtain said feedback signal.

Preferably, said detection module is further configured to detect that an incoming call has hung up, the data generated in the transmission resuming signal is detected when an incoming call hangs up.

### BRIEF DESCRIPTION OF THE DRAWINGS

FIG. 1 is a flowchart of a data signal transmission method in an embodiment;

FIG. 2 is a schematic diagram of spectrum changes before and after spread spectrum processing of a data signal in an embodiment;

FIG. 3 is a structure diagram of physical audio jack plugs in an embodiment;

FIG. 4 is a structure diagram of a data signal transmission system in an embodiment;

FIG. 4A is a illustration of a headphone according to an embodiment of the invention;

FIG. 5 is a structure diagram of a data signal transmission system in another embodiment;

FIG. 6 is a flowchart of a signal transmission control method in an embodiment; and

FIG. 7 is an illustration of yet another embodiment.

### DETAILED DESCRIPTION OF THE INVENTION

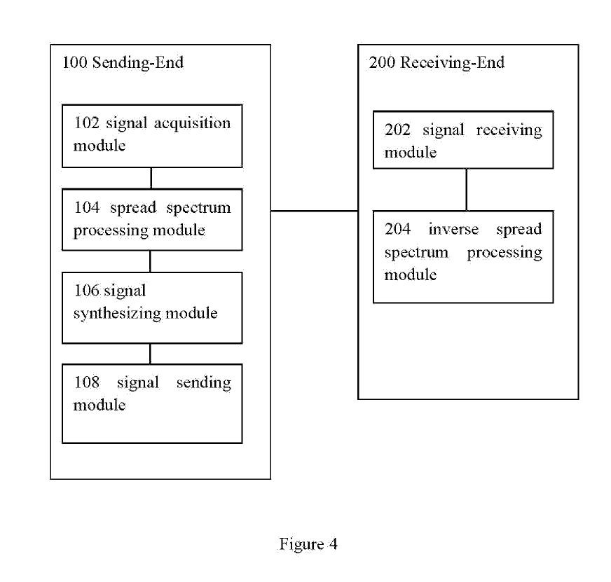

FIG. 4A shows a multi-functional headphone 900 which is capable of communicating, at 905, with a mobile phone 910.

The headphone 900 has ear phones which are placed over the ears of the wearer, so that the wearer may listen to analogue audio signal transmission from the mobile phone 910.

The headphone 900 also has a microphone 920 into which the wearer may speak, so that his speech can be converted into an analogue audio signal and transmitted to the mobile phone 910, to be further transmitted by a telecommunication operator to a conversation party. An analogue audio signal typically has a frequency spectrum ranging between 20 hz to 20 khz.

Provided in the ear phones is at least one sensor (not visible in FIG. 4A). In this first embodiment, the sensor is a heartbeat sensor capable of monitoring the pulsation of blood flow in the ear. The heartbeat sensor is therefore able to collect data in the form data signal of the pulsation indicating the wearer's heart rate. Typically, the data signal is a pulse signal where each pulse represents one heartbeat. Each pulse signal has a narrower frequency band than analogue audio signals captured by the microphone 920 from the voice of the wearer. The headphone 900 sends the pulse signals to the mobile phone 910 for heart rate monitoring, such as for use by exercise monitoring applications in the mobile phone. Typically, each pulse signal has a bandwidth below a pre-determined threshold, which is preferably, 4 khz. In addition, the data signal has smaller power spectral density and also a smaller data size than that of the analogue audio signal. The data size is typically less than 10 bytes/second.

Optionally, however, the sensor may be replaced by anyone of or any combination of two or more sensors, such as the heartbeat sensor, a body temperature sensor, a blood pressure sensor or a motion sensors etc. The motion sensor can be a single axis or multi-axis gyrometer or a accelerometer. Therefore, data signals collected by the headphone 900 are typically biological or physiological data such as heart rate, body temperature, blood pressure, movements etc.

Typically, a wire extends from the headphone 900 ends in a phone connector suitable for being plugged into a 3.5 mm audio jack or audio jack. That is, a physical wire connects the multi-function headphone 900 to a mobile phone 910.

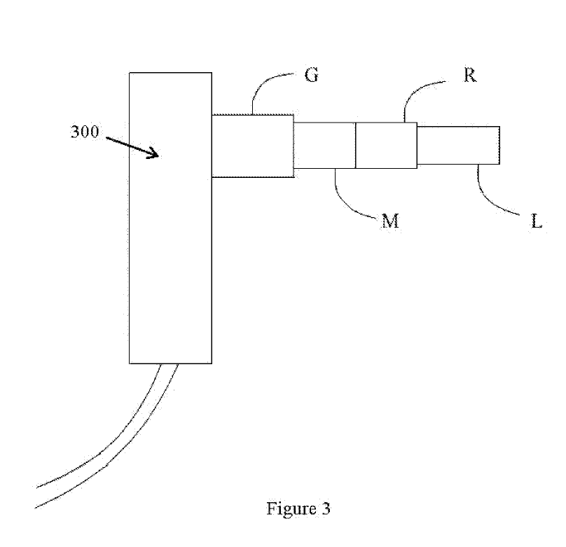

FIG. 3 shows a standard 3.5 mm audio jack phone connector 300 comprising four analogue channels, L, R, G and M. L and R are the respective left and right channels of the audio jack, M is the microphone 920 channel, and G is ground.

Typically, analogue signals are sent from the mobile phone 910 to the headphone 900 by channels L and R, so that the wearer may listen to the analogue audio signals. Channels L and R are therefore usually uni-directional from the mobile phone 910 to the headphone 900.

Analogue signals are sent from the microphone 920 to the headphone 900 by channel M, so that the wearer's speech may be transmitted to the mobile phone 910 to be sent to the conversation party. Channel M is therefore usually uni-directional from the microphone 920 to the mobile phone 910.

FIG. 4 is a schematic diagram of a data signal transmission system between the multi-function headphone 900 and the mobile phone 910. To transmit an analogue audio signal from the microphone 920 to the mobile phone 910, there is a sending-end 100 defined in the multi-function headphone 900 and a receiving-end 200 in the mobile phone 910. The sending-end 100 and the receiving-end 200 communicate by the wire connecting the headphone 900 to the mobile phone 910.

The sending-end 100 comprises a signal-acquisition-module 102, a spread-spectrum-processing-module 104, a signal-synthesizing-module 106 and a signal-sending-module 108.

The receiving-end 200, on the other hand, comprises a signal-receiving-module 202 for receiving the mixed signal and an inverse spread-spectrum-processing-module 204. The inverse spread-spectrum-processing-module 204 is for carrying out inverse spread spectrum processing on the mixed signal to provide a data signal.

In a best mode embodiment, the signal-acquisition-module 102 is collecting data signal representing the wearer's heart rate at the same time as the wearer of the headphone 900 is speaking into the microphone 920. Therefore, both an analogue audio signal of the speech and a data signal of the heart rate have to be transmitted to the mobile phone 910.

The spread-spectrum-processing-module 104 therefore multiplies the data signal with a pre-determined spreading code to produce a ‘spread spectrum signal’. A spreading code is typically a high-rate spread spectrum sequence. Typically, the bandwidth of the data signal is relatively narrow before being multiplied or spread with the spreading code. Multiplying the spreading code with the data signal converts the data signal from a narrow bandwidth signal into a broad bandwidth signal, that is, a signal which is very much more spread out in the frequency domain that the original data signal, and possibly shifted to be over a range of higher frequencies. The multiplication is typically done via a multiplication circuit (not illustrated). Preferably, the spread-spectrum-processing-module 104 carries out Direct Sequence Spread Spectrum (DSSS) processing on the data signal. Optionally, however, the spread-spectrum-processing-module 104 carries out the spread spectrum processing by Orthogonal Code Spread Spectrum (OCSS), Frequency-Hopping Spread Spectrum (FHSS) and so on.

The spread-spectrum-processing-module 104 performs the spreading by phase-shift keying (PSK) of the data signal. In this case, the carrier frequency of the PSK is preferably 18 khz. The highest frequency on the spectrum of the spread spectrum signal is typically 22.1 khz.

However, the analogue audio signal is not treated by the spreading code.

Subsequently, the signal-synthesizing-module 106 synthesizes the spread spectrum signal and the analogue audio signal into a ‘mixed signal’, such as by adding the spread spectrum signal to the analogue audio signal using an addition circuit (not illustrated).

The signal-sending-module 108 then transmits this mixed signal to the receiving-end 200.

In the prior art, a mobile phone 910 is unable to handle more than one signal at the audio jack. In this embodiment, however, both the spread spectrum signal and the analogue audio signal are transferred as one combined analogue signal from the headphone 900 to the mobile phone 910, through the same wire.

Therefore, the signal-receiving-module 202 in the receiving-end 200 receives the mixed signal. The inverse spread-spectrum-processing-module 204 then captures an accurate phase of the spreading code through a synchronization capture module and thereby generates a spreading code phase which is completely identical with the phase of the spreading code at the sending-end 100. This generated spreading code phase is a local ‘despread spectrum signal’. The local despread spectrum signal can be multiplied with the mixed signal to retrieve the data signal.

The despreading is a mathematical treatment which will suppress the analogue signal while extracting data signal, and there is no need to separate the spread spectrum signal from the analogue audio signal in the mixed signal in order to extract the data signal.

In the event that the signal-acquisition-module 102 fails to acquire an analogue audio signal, such as when the wearer is not speaking into the microphone 920, the signal-sending-module 108 will send only the spread spectrum signal to the receiving-end 200. The receiving-end 200 will simply continue to receive information on the wearer's heart rate.

The heart rate may be used by the mobile phone 910 to monitor the state of health or exertion of the wearer. On the other hand, if the signal-acquisition-module 102 fails to acquire a data signal, such as if the sensor monitoring heart rate malfunctions, the signal-sending-module 108 will send only the analogue audio signal to the receiving-end 200 so that any tele-conversation can be continued without disruption.

Optionally, the mixed signal is encoded or modulated before transmission from the sending-end. In this case, the inverse spread-spectrum-processing-module 204 also comprises capability for decoding and/or demodulating the mixed signal before despreading.

Therefore, the embodiment as described allows two sources of information to be sent as one mixed signal though an audio jack between a headphone (or any device) to a mobile phone (or any complementary device).

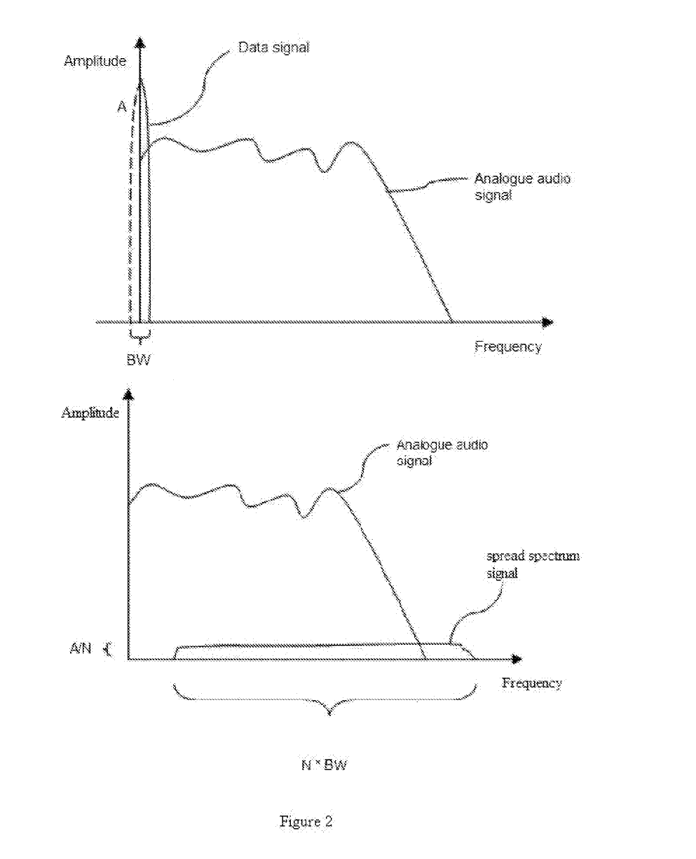

FIG. 2 shows two power spectral density-frequency charts, illustrating the power distribution of the signal which is transmitted from the sending-end 100. The part of the top chart indicated ‘A’ is the power spectral density of the data signal. The lower chart has a portion marked ‘N’, which is the spread spectrum gain. ‘BW’ indicates the frequency bandwidth. The charts illustrate an audible signal within the typical range of generally 20 hz˜20 khz.

The top chart shows a data signal having a narrow bandwidth about the x-axis representing frequency and also a high power. The same chart shows an analogue audio signal which is spread over a large bandwidth and having high power, as is typical for human voice.

The bottom chart shows the data signal after it has been spread processed using the spreading code, converting the data signal into a spread spectrum signal, having now a broad bandwidth with a lower spectra power.

On one hand, the analogue audio signal between 20 hz˜20 khz may be regarded as strong noise in the spread spectrum signal. Such strong noise at 20 hz˜20 khz causes relatively low interference in the spread spectrum signal on the whole when the spread spectrum signal is despread. This allows the despread data signal retrieved from the mixed signal to have low bit error rate and to suffer less impact from the analogue audio signal; despreading of the mixed signal will diminish the presence of the analogue audio signal while retrieving the data signal.

On the other hand, as the spread spectrum signal has a wider frequency range and that it has a lower power spectral density within the range of 20 hz˜20 khz, the spread spectrum signal may be regarded as very low level noise in the analogue audio signal. In particular, the signal-synthesizing-module 106 has preferably adjusted the power spectral density of the spread spectrum signal before generating the mixed signal. Therefore, the spread spectrum signal is inaudible even if the receiving-end 200 receives and plays the mixed signal directly through an audio play device, without filtering away the spread spectrum signal. For example, the mobile phone may play aloud the speech of the wearer which he speaks into the microphone, and the data signals indicating the wearer's heart rate is undetectable by the a listener. This is because the audible range to the human ear is about 20 hz˜20 khz, and the spread spectrum signal has a wide spectrum range that may stretch over 20 khz but has a low power spectral density within the range of 20 hz˜20 khz.

More specifically, the low interference effect from the spread spectrum signal on the analogue audio signal is provided because the signal-synthesizing-module 106 adjusts the power of the spread spectrum signal, such that the spread spectrum signal is below a pre-determined ratio to the power of the analogue audio signal. Alternatively, the signal-synthesizing-module 106 simply adjusts the power of the spread spectrum signal until it is below an absolute power threshold level.

Furthermore, even if the mixed signal comprising the analogue audio signal is encoded into a digital analogue audio signal or directly input to an audio play device, the contribution of the spread data signal within the range of 20 hz˜20 khz is relatively low.

Prior to this embodiment, conventional use of the audio jack is limited in use to only analogue audio signal transmission from the headphone 900 to the mobile phone 910. The audio jack was not used to transfer any information other than analogue audio signals through the same wire. If the data signal were not spread processed, sending the data signal through the same audio wire as the analogue audio signal will create an annoying noise which can be heard by conversation party at the other side of the telephone call.

Therefore, the preset embodiment provides an expanded and extended use of the audio jack. The resulting advantage is that many older version mobile phones 910 having only this audio jack and no other ports for data communication is now able to process more information than just an analogue audio signal. Owners of older mobile phones 910 may now find their mobile phone capabilities expanded to more uses. All that needs to be upgraded is the software in these older phones to perform despreading and providing a headphone 900 with spread processing functions.

In a variation of the embodiment, the sending-end and the receiving-end are reversed in location; the sending-end 100 is set in the mobile phone 910 instead of the headphone 900 and the receiving-end 200 is set in the headphone 900 instead of the mobile phone 910. In this case, the data signal is a control instruction generated in the mobile phone 910. The control instruction is processed by multiplying it with the spreading code, and then mixed with an analogue audio signal incoming into the mobile phone 910. The mixed signal is sent to the headphone 900 so that the wearer can listen to the analogue audio signal. The control instruction may be a button-triggered instruction for controlling a sensor switch regulating the volume in the multi-function headphone 900. As in the earlier embodiment, the data signal corresponding to the control instruction is preferably a pulse signal with a bandwidth below the threshold. Optionally, instead of an incoming analogue audio signal which is part of a tele-conversation, the analogue audio signal is of a piece of music played on the mobile phone 910 transmitted the headphone 900.

Therefore, an embodiment has been described in which two sets of information are sent through a common audio signal wire at the same time, but without causing interference to the analogue audio signal which the wearer hears or which is transmitted to the conversation party.

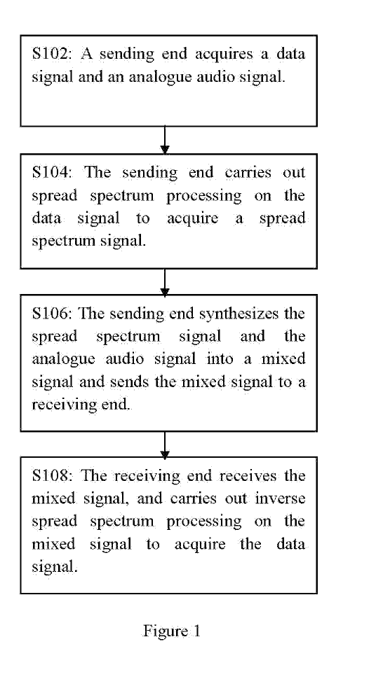

FIG. 1 is a flowchart showing the steps executed by the described embodiment in obtaining and transmitting the data signal.

At Step S102, the sending-end 100 acquires a data signal and an analogue audio signal. The sending-end 100 in this case refers to the headphone 900, which comprises the microphone 920 and the sensor in the headphone providing signals to be transmitted to the mobile phone 910. Therefore, an analogue audio signal such as a voice signal is collected by the microphone 920 while a data signal is collected by the sensor representing the wearer's heart rate.

At Step S104, spread spectrum processing is performed on the data signal at the sending-end 100 to produce a spread spectrum signal.

At Step S106, the spread spectrum signal and the analogue audio signal are synthesized, or combined, into a mixed signal, and transmitted from the sending-end 100 to the receiving-end 200.

At Step S108, the receiving-end 200, i.e. the mobile phone 910, receives the mixed signal and carries out inverse spread spectrum processing on the mixed signal in order to retrieve the data signal. Specifically, this comprises a step of the receiving-end 200 firstly capturing an accurate phase of the sent spreading code through a synchronization capture module of the spreading code. The receiving-end then generates a spreading code phase which is completely identical with the spreading code phase at the sending-end 100, and which is use-able as a local despread spectrum signal. Subsequently, the receiving-end 200 multiplies the local despread spectrum signal by the mixed signal. This restores the spread spectrum signal to its original data signal, in the original bandwidth and power state. There is no need to separate the spread spectrum signal and the analogue audio signal before apply the despread spectrum signal. Optionally, the local despread spectrum signal is pre-determined and pre-stored in the mobile phone 910 for despreading spread spectrum signal from the headphone 900.

Preferably, the spreading code used at the sending-end 100 is an orthogonal spreading code. In this case, the inverse spread spectrum processing simply comprises multiplying the orthogonal spreading code and the mixed signal at the receiving-end 200. Optionally, the spread spectrum signal is filtered to more accurately retrieve the data signal.

As mentioned, the signal-synthesizing-module 106 adjusts the power of the spread spectrum signal to a pre-determined ratio to the power of the analogue audio signal. This ensures any contribution of noise by the spread spectrum signal to the analogue audio signal is kept below a certain threshold. Alternatively, the signal-synthesizing-module 106 adjusts the overall power of the spread spectrum signal to be below a certain threshold regardless of the power of the analogue audio signal, which also limits noise contribution from the spread spectrum signal. In this way, the sending-end 100 ensures noise power in the analogue audio signal contributed by the spread spectrum signal is kept to a limit, making it possible for the receiving-end 200 to play the mixed signal directly to produce a virtually or practically noise-free audible sound to a listener, without having to remove or filter away the spread spectrum signal first.

In the above embodiments, the sending-end 100 is defined as the headphone 900, where the user's heart rate is collected as well as his speech, both to be transmitted to the mobile phone 910. In this case, the headphone 900 sends the mixed signal to the receiving-end 200 through the M channel. However, when the mobile phone 910 sends an analogue audio signal from the mobile phone 910 to the headphone 900, the sending-end 100 is defined as being located on the mobile phone 910 and the receiving-end 200 on the multi-function headphone 900. In this case, the sending-end 100 sends an analogue audio signal, or a mixed signal synthesized from the analogue audio signal and the spread spectrum signal, to the receiving-end 200 through the L and/or R channel.

In other possible embodiments, the sending-end 100 sends the mixed signal to the receiving-end 200 by means of wireless transmission after modulating the mixed signal. The form of wireless transmission may be Bluetooth, infrared, etc. The mixed signal may be firstly modulated with a relatively high carrier frequency (2.4 ghz in the case of Bluetooth), transmitted and then demodulated, and acquired.

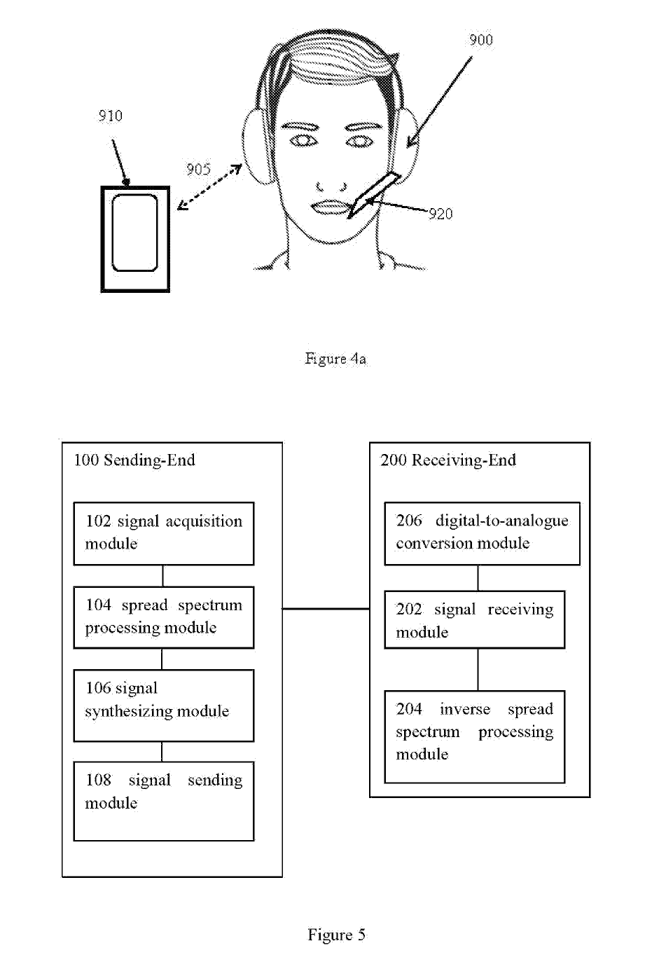

FIG. 5 is a schematic diagram of a variation of the embodiment of FIG. 4, wherein the receiving-end 200 further comprises a digital-to-analogue conversion module 206. The digital-to-analogue conversion module 206 is capable of encoding the received mixed signal into a digital analogue audio signal with PCM (Pulse-code modulation) encoding. A digital analogue audio signal obtained by this encoding is used as digital input to mobile phone 910 software applications.

In most conventional mobile phone 910 and headphone 900 designs, the headphone 900 has less computing power than the mobile phone 910. That is, the headphone 900 having processor which has a lower computing capacity then the processor. Therefore, most conventional mobile phone 910 and headphone 900 have unequal processing power. In this case, it will be easier for a data signal to be spread processed in the mobile phone 910 than to be spread processed in the headphone 900, as spreading requires more processing than despreading. Therefore, to avoid over burdening the processor in the headphone 900, the headphone 900 only collects data signal when there is no on-going mobile phone 910 conversation. If a mobile phone 910 call comes in to the mobile phone 910, and an analogue audio signal from a conversation party has to be transmitted to the headphone 900, the headphone 900 will stop collecting data signal and concentrate on processing the analogue audio signal to let the wearer listen to the conversation party and to reply by the microphone 920. Such a method of conserving processing power in the headphone 900 requires the headphone 900 to be alerted whenever a mobile phone 910 call is coming in, and alerted whenever the call is hung up.

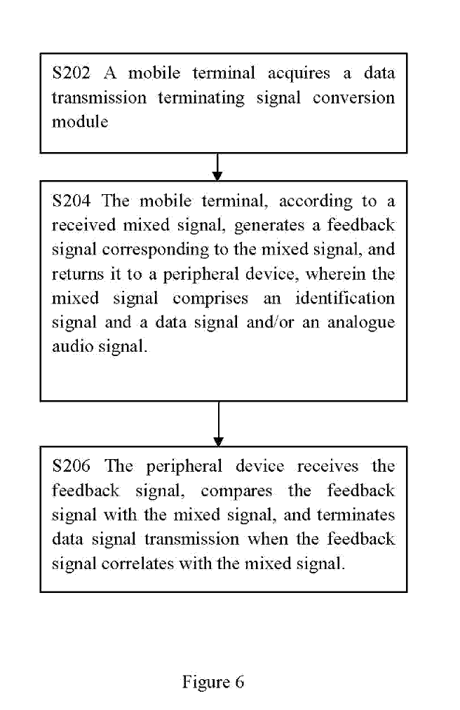

FIG. 6 shows how to alert the headphone 900 to stop collecting data signal when a telephone call comes in, which comprises the following steps at the receiving-end 200.

In Step S202, the mobile phone 910 detects an incoming call.

Subsequently, in Step S204, the mobile phone 910 generates a feedback signal for sending from the mobile phone 910 to the headphone 900. The feedback signal is generated by using the same signal which is being transmitted from the headphone 900 to the mobile phone 910. That same signal is processed to have a reduced power spectral density. The feedback signal is therefore like an echo of the analogue audio signal being transmitted to the mobile phone 910.

Subsequently, in Step S206, the multifunctional headphone 900 receives the feedback signal. The multifunctional headphone 900 compares the feedback signal with the mixed being sent signal, and the two signals would be almost identical. Therefore, the feedback signal correlates with the mixed signal. On detecting the correlation, the multifunctional headphone 900 terminates data signal transmission, or stops collecting data signals, or stops combining the data signal with the analogue audio signal. Therefore, this embodiment uses the wire to send information from the mobile phone 910 to the headphone 900 for controlling headphone 900 functions, without needing other input or output ports; only the conventional audio signal jack is used. When the mobile phone 910 stops sending the feedback signal, the multifunctional headphone 900 resumes data signal transmission, and continues to collect data signal and combine the data signal with the analogue audio signal.

In a variation of the embodiment, instead of using the feedback signal to indicate to the headphone 900 to stop data signal transmission, an identification signal is sent to the headphone 900 continually to let the headphone 900 know to continue acquiring data signal, spreading the data signal and sending the data signal to the mobile phone 910 through the analogue audio wire. Detection of this identification signal means that there is no mobile phone 910 conversation and the headphone 900 continues to collect data signal. If the mobile phone 910 detects an incoming call, this identification signal is no longer sent by the mobile phone 910 to the headphone 900. The headphone 900 detects absence of the identification signal and stops collecting or transmitting data signal.

Optionally, the mobile phone 910 is also capable of detecting whether the incoming call has hung up and, if so, generates a data-transmission-restoring-signal. In this way, the mobile phone 910 is able to inform the multifunctional headphone 900 in real time to restore data signal transmission.

In the event the headphone 900 is transmitting heart rate signals to the mobile phone 910, but the wearer is not engaging in a conversation, but the mobile phone 910 detects an incoming telephone call, the mobile phone 910 generates a data-transmission-terminating-signal upon detecting the incoming call.

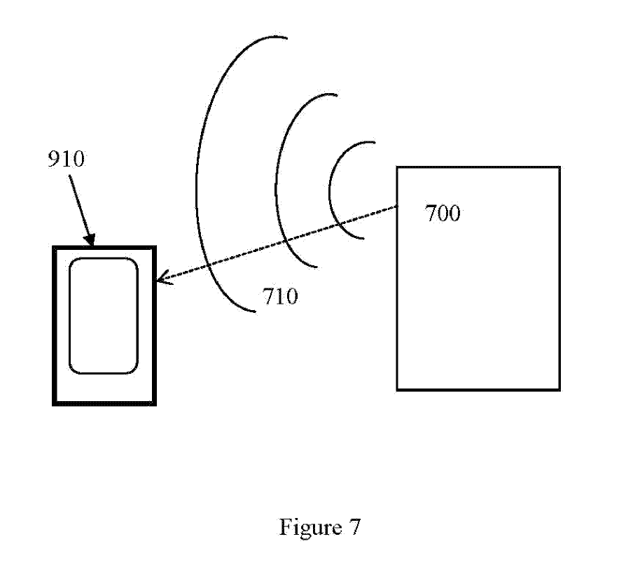

Other embodiments of sending data signals via an analogue signal channel for controlling devices is possible. For example, as shown in FIG. 7, the microphone (not the aforementioned microphone 920 in the headphone 900) of a mobile phone 910 into which a person speaks can be set to pick up an analogue signal broadcasted into the surroundings by a loudspeaker system 700. This ‘ambient’ analogue signal broadcasted, at 710, into the surroundings can be a piece of music, or news reading and so on. The loudspeaker system 700 can be one of those which blast announcement or music in a large hall. Typically, a data signal which has been spread and transformed into a spread spectrum signal is mixed with the analogue audio signal, and the mixed signal is broadcasted. The human ear cannot detect the spread spectrum signal. The data signal can embody a text message. The mobile phone 910 is configured to perform a despreading on all received analogue audio signal to see if a data signal mixed into the analogue audio signal can be retrieved. If the data signal is retrieved, the text message is displayed in the screen of mobile phone 910. In this way, a text message can be broadcasted by a loud speaker as part of an analogue audio signal, detected by all mobile phones 910 within detection vicinity and displayed by the mobile phones 910. Accordingly, this embodiment allows analogue signals containing a text message to be broadcasted together with analogue audio signals, such that the text message can be retrieved by any device capable of despreading the mixed signal. This embodiment will find application in helping people who are hard of hearing to be kept updated by the text messages with important audio announcements being made through a public announcement system.

Optionally, the text message can be replaced by an instruction which instructs the device to do something or perform a function.

The embodiments as discussed above only represent several modes of implementing the present invention. Despite the specific and detailed descriptions, these embodiments are not to be understood as limiting the scope of the present invention thereto on such basis. It should be pointed out that persons of ordinary skills in the art, without departing from the conception of the present invention, would further make a number of transformations and improvements within the scope of protection of the present invention. Therefore, the scope of protection of the present invention shall be determined by the attached claims.

For example, although a mobile phone which has an analogue audio jack has been mentioned in the description of embodiments, any device which can receive an analogue signal can be used in place of the mobile phone. This includes any device which can receive analogue audio signals such as a computer notebook, a personal digital assistant (PDA), any form of smart phones as the case may be.

Also the analogue signal can be transmitted wirelessly without need of a wire. Also, the analogue signal can be any analogue signal that can be picked up by the device, even in the radiofrequency domain, microwave domain, visible light domain, invisible light domain and so on. Also, it is possible in some embodiments that the analogue signal is converted to digital signals for transmission from the sending end to the receiving end, and to be restored from the digital to analogue at the receiving end before despreading is applied. In some other embodiments, the digitized signal can be directly despread without the signal having been re-converted into analogue, as this only depends only the mathematical treatment which the skilled man can design.

1. A method of transmitting data between a mobile phone and a headphone plugged into an analogue audio jack of the mobile phone, comprising the steps of:
providing a data signal;
spreading the data signal to produce a spread spectrum signal;
sending the spread spectrum signal from the mobile phone to the headphone and inverse-spread-processing the spread spectrum signal in the headphone to retrieve the data signal; or
sending the spread spectrum signal from the headphone to the mobile phone and inverse-spread-processing the spread spectrum signal in the mobile phone to retrieve the data signal.

2. The method of transmitting data between a mobile phone and a headphone plugged to the analogue audio jack of the mobile phone as claimed in claim 1, further comprising the steps of:
providing an analogue signal;
combining the analogue audio signal and the data signal into a mixed signal;
wherein
the spread spectrum signal is sent from the mobile phone to the headphone as part of the mixed signal; or
the spread spectrum signal is sent from the headphone to the mobile phone as part of the mixed signal.

3. The method of transmitting data between a mobile phone and a headphone plugged to the analogue audio jack of the mobile phone, as claimed in claim 2, further comprising:
the data signal triggering operation of a function in the headphone when the mixed signal is sent from the mobile phone to the headphone and the inverse-spread-processing of the spread spectrum signal in the headphone to retrieve the data signal; or
the data signal triggering operation of a function in the mobile phone when the mixed signal is sent from the headphone to the mobile phone and the inverse-spread-processing the spread spectrum signal in the mobile phone to retrieve the data signal.

4. The method of transmitting data between a mobile phone and a headphone plugged to the analogue audio jack of the mobile phone, as claimed in claim 2, wherein
the data signal contains information to be played or displayed in the mobile phone.

5. The method of transmitting data between a mobile phone and a headphone plugged to the analogue audio jack of the mobile phone, as claimed in claim 1, wherein the audio jack is a wired 3.5 mm audio jack.

6. A method for transmitting data signal from an analogue signal sending-end to an analogue signal receiving-end, comprising the steps of:
providing a data signal;
spread processing the data signal to produce a spread spectrum signal having a wider bandwidth than a bandwidth of the data signal and a smaller power spectral density than a power spectral density of the data signal;
sending the spread spectrum signal to the receiving end;
inverse-spread-processing the spread spectrum signal to retrieve the data signal.

7. The method for transmitting data signal from an analogue signal sending-end to an analogue signal receiving-end as claimed in claim 6, comprising the further steps of:
providing an analogue signal;
combining the analogue signal and the spread spectrum signal into a mixed signal; wherein
sending the spread spectrum signal to the receiving end includes sending the mixed signal to the receiving end.

8. The method for transmitting data signal from an analogue signal sending-end to an analogue signal receiving-end as claimed in claim 7, comprising the further steps of:
converting the mixed signal into a digital signal before sending the mixed signal to the receiving end; and
converting the mixed signal into an analogue signal at the receiving end.

9. A device for transmission of an analogue audio signal comprising
a sensor for obtaining a data signal;
the device capable of code spreading the data signal to produce a spread spectrum signal, the spread spectrum signal having a frequency bandwidth broader than a bandwidth of the data signal and having an power spectral density lesser than a power spectral density of the data signal; wherein
the device is capable of transmitting the spread spectrum signal.

10. The device for transmission of an analogue audio signal as claimed in claim 9, wherein,
the device is capable of obtaining an analogue audio signal;
the device is capable of adding the spread spectrum signal to the analogue audio signal to provide a mixed signal; and
the device is capable of transmitting the spread spectrum signal as part of the mixed signal.

11. The device for transmission of an analogue audio signal as claimed in claim 9, wherein, the device is capable of transmitting the spread spectrum signal by an analogue signal jack.

12. The device for transmission of an analogue audio signal as claimed in claim 9 wherein, the sensor is a heart rate sensor, a temperature sensor, a gyrometer, an accelerometer and combinations thereof.

13. The device for transmission of analogue audio signal as claimed in claim 9 wherein, the device is a microphone, a headphone or a mobile terminal.

14. The device for transmission of analogue audio signal as claimed in claim 9 wherein, the spread spectrum signal contains information on biological or physiological data of a human or living thing.

15. A mobile phone having an audio jack, wherein the audio jack is adapted for receiving a spread data signal which has been code spread, the mobile phone having a despreading module for despreading the spread data signal for obtaining a despread data signal as an instruction for operating a function of the mobile phone.

16. A loudspeaker system for sending a data signal wherein
the loudspeaker system is capable of playing an audible analogue signal mixed with a spread spectrum signal;
the spread spectrum signal being a data signal which has been spread processed to have a relatively low spectral power compared to a spectral power of the audible analogue signal, the data signal representing a text message; and
the spread spectrum signal being adapted for despreading to retrieve the data signal by a device capable of receiving the audible analogue signal mixed with the spread spectrum signal.

17. A device suitable for receiving data mixed with an analogue signal in a spread spectrum signal; wherein
the device is capable of despreading spread spectrum signals received by a receiver thereof; wherein
when any spread spectrum signal is detected, the device applies a despreading process on the spread spectrum signal to receive the data mixed with the analogue signal.

18. The device suitable for receiving data mixed with an analogue signal as claimed in claim 17; wherein
the receiver is capable of receiving analogue signals; and,
the spread spectrum signal is mixed with the analogue signal.

19. The device suitable for receiving data mixed with an analogue signal as claimed in claim 17, wherein the analogue signal is an analogue audio signal.

20. The device suitable for receiving data mixed with an analogue audio signal as claimed in claim 17, wherein the data contained in the spread spectrum signal is biological or physiological data of a human or living thing.
